(19) United States
(12) Patent Application Publication
(10) Pub. No.: US 2008/0226116 A1
(43) Pub. Date: Sep. 18, 2008

(54) Diaphragm and Loudspeaker Using Same

(76) Inventor: Osamu Funahashi, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/585,848

(22) PCT Filed: Nov. 18, 2005
(86) PCT No.: PCT/JP2005/021225

§ 371 Date: Jul. 12, 2006

(30) Foreign Application Priority Data
Nov. 22, 2004 (JP) 2004-337115

(51) Int. Cl. H04R 1/00; H04R 7/12; H04R 9/06

(52) U.S. Cl. 381/423; 181/173; 381/398

(57) ABSTRACT

Diaphragm (9) has through-hole (10) for fixing a voice coil at its center part, and has a fixing part of edge (12) at its outer periphery whose shape is substantially circular. The shape of the outer periphery of diaphragm (9) is formed as follows: first circle and second circle (9A, 9B) are overlapped each other with their center points (9a, 9b) displaced in such a manner that at least one part of an outer periphery of first circle and second circle (9A, 9B) forms a part of the substantially circular outer periphery of an entire shape. Signal reproduction characteristics can be flattened as much as possible by reducing a resonance level.

### TECHNICAL FIELD

The present invention relates to a diaphragm and a loudspeaker using the same.

### BACKGROUND ART

Each loudspeaker generates natural resonance vibration frequency.

Therefore, a reproduction level fluctuates extraordinary at the resonance vibration frequency compared with other frequencies, so that reproduction frequency characteristics are difficult to be flattened. As a result, there is a problem that a signal can not be reproduced appropriately.

To solve this problem, Unexamined Japanese Patent Publication No. H7-162992 discloses that a resonance level of a diaphragm at the natural vibration frequency can be suppressed by making an outer periphery of the diaphragm an oval figure, for example.

As the example discussed above, making the outer periphery of the diaphragm an oval figure, for example, has a certain effect for suppressing the resonance level at the natural vibration frequency. However, the high resonance level at the natural vibration frequency is still becoming a problem.

### SUMMARY OF THE INVENTION

A diaphragm for a loudspeaker has a shape overlapping a first circle and a second circle in a top view of an outer periphery shape of the diaphragm,

where the first circle has a first center point and a first radius, and the second circle has a second center point different from the first center point and a second radius different from the first radius. By forming the shape discussed above, signal reproduction characteristics can be flattened as much as possible.

### BRIEF DESCRIPTION OF THE DRAWINGS

FIG. 1 is a sectional view of a loudspeaker in accordance with an exemplary embodiment of the present invention.

FIG. 2 is a plan view of a diaphragm in accordance with the exemplary embodiment of the present invention.

FIG. 3 is a plan view showing a shape of the diaphragm in accordance with the exemplary embodiment of the present invention.

FIG. 4 is a signal reproduction characteristic in accordance with the exemplary embodiment of the present invention.

### REFERENCE MARKS IN THE DRAWINGS

1 frame
2 magnetic circuit
3 magnet
4 yoke
5 plate
6 magnetic gap
7 voice coil
9 diaphragm
9A first circle
9B second circle
9C third circle
9a, 9b, 9c center point
10 through-hole
12, 14 edge
12a cushion part
12b, 12c flange
13 dumper
15 fixing part
100 loudspeaker

### DETAILED DESCRIPTION OF PREFERRED EMBODIMENTS

The inventor considers the reason that fluctuation of a resonance level at a natural vibration frequency is difficult to be suppressed in a conventional diaphragm as follows. In an oval diaphragm, when a plurality of center points are drawn from an outer periphery of the diaphragm, each center line has a constant distance at the same angle position in right and left directions with respect to the center point. The inventor has found that this is the reason that the resonance level can not be reduced as expected.

A diaphragm of the present invention is characterized by a shape of its outer periphery. The shape of the outer periphery of this diaphragm is formed as follows: A first circle and a second circle are overlapped each other with their center points displaced in such a manner that at least one part of an outer periphery of the first circle and the second circle forms a part of the substantially circular outer periphery of an entire shape of the diaphragm. Using this shape, most center lines drawn from an edge of the outer periphery to the center point have different distances at right side and left side from the center point of the diaphragm. This can reduce the resonance level remarkably. As a result, signal reproduction characteristics can be flattened as much as possible.

Exemplary embodiments of the present invention are demonstrated hereinafter with reference to the accompanying drawings.

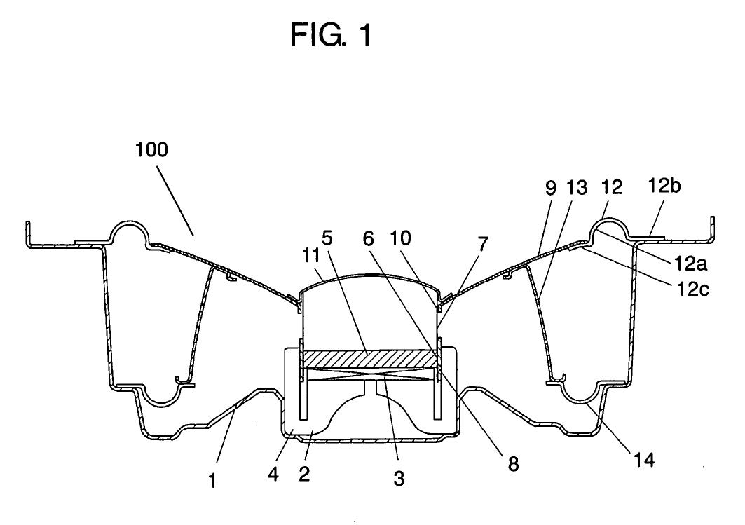

FIG. 1 is a sectional view of loudspeaker 100 in accordance with the exemplary embodiment of the present invention. Loudspeaker 100 shown in FIG. 1 accommodates magnetic circuit 2 at an inner bottom surface of dish-shaped frame 1. Magnetic circuit 2 includes magnet 3, yoke 4 and plate 5. Magnetic gap 6 is formed between yoke 4 and a tip of plate 5.

Coil part 8 which is a lower end part of cylindrical voice coil 7 is movably accommodated in magnetic gap 6. In addition, an upper end of voice coil 7 penetrates through-hole 10 of a center of diaphragm 9 and projects upward. Voice coil 7 and diaphragm 9 are fixed at the penetrating position by using an adhesive. Moreover, cap 11 covers an upper end of voice coil 7.

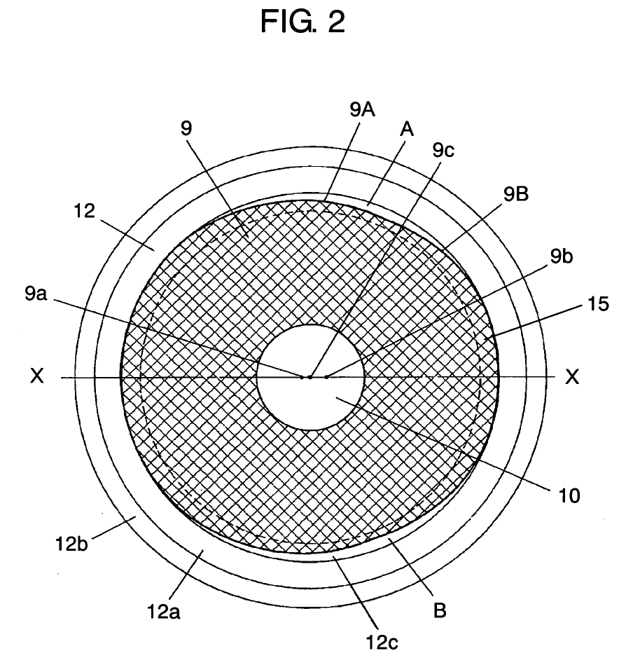

As shown in FIGS. 1 and 2, diaphragm 9 has through-hole 10 for fixing voice coil 7 at its center part, and has fixing part 15 of edge 12 at its outer periphery whose shape is substantially circular. The shape of the outer periphery of diaphragm 9 is formed as follows: First circle 9A and second circle 9B are overlapped each other with their center points 9a and 9b displaced in such a manner that at least one part of an outer periphery of the first circle and the second circle forms a part of the substantially circular outer periphery of an entire shape.

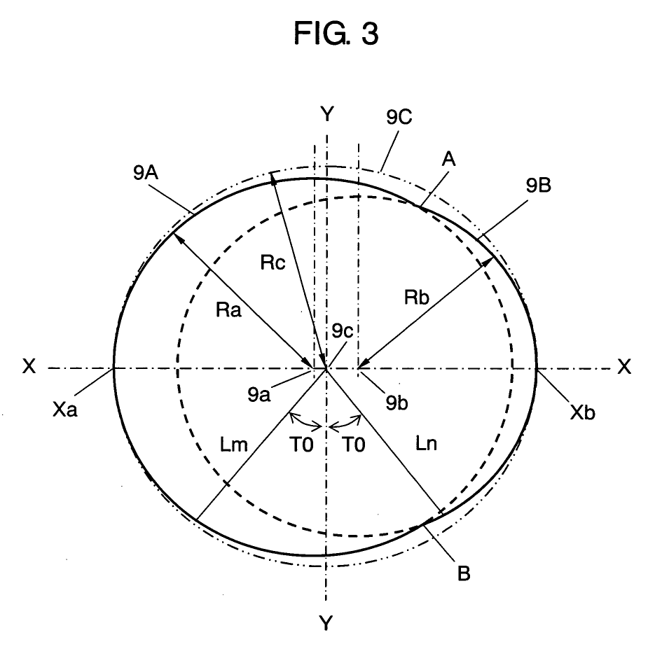

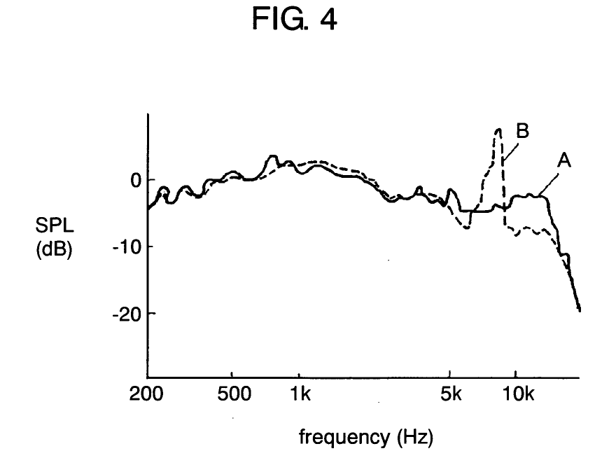

Using FIG. 3 of a top view of diaphragm 9, the shape of the diaphragm is described hereinafter in more detail. First circle 9A has radius Ra and center point 9a. Second circle 9B has radius Rb and center point 9b. Third circle 9C has radius Rc and center point 9c, and surrounds first circle 9A and second circle 9B. Further, third circle 9C contacts an outer periphery of first circle 9A at point Xa on line X-X, and contacts an outer periphery of second circle 9B at point Xa on line X-X. The outer periphery of first circle 9A and the outer periphery of second circle 9B cross each other at point A and point B. A solid line denotes the outer periphery of diaphragm 9. In a word, the outer periphery of small circle 9B whose radius is Rb is shown from point A to point B in clockwise direction, and the outer periphery of large circle 9A whose radius is Ra is shown from point B to point A in clockwise direction. Most center lines drawn from the outer periphery to center point 9c of third circle 9C have different distances at right side and left side of center point 9c. For example, distance Lm, which is defined as a distance from center point 9c to the outer periphery of first circle 9A at angle T0 with respect to line Y-Y in a left direction, differs from distance Ln, which is defined as a distance from center point 9c to the outer periphery of second circle 9B at angle T0 with respect to line Y-Y in a right direction. However, distances at right side and left side become the same only at center line X-X. This causes the resonance level to reduce remarkably. As a result, as shown in FIG. 4, the signal reproduction characteristics can be flattened as compared with conventional line B. Particularly, the frequency characteristic at near 10 kHz is considerably flattened as compared with conventional one. In FIG. 4, SPL stands for “output sound pressure level” and is shown as a value of dB.

According to edge 12 shown in FIG. 1, cushion part 12a, which protrudes upward and has a semicircular cross section, forms a circular shape as shown in FIG. 2. In addition, circular flange 12b for being fixed at frame 1 is formed at an outer periphery of cushion part 12a, and circular flange 12c for being fixed at diaphragm 9 is formed at an inner periphery of cushion part 12a.

An end of an inner periphery of ring-shaped dumper 13 is fixed to a lower surface of diaphragm 9, and an end of an outer periphery of dumper 13 is fixed to frame 1 via edge 14.

### INDUSTRIAL APPLICABILITY

According to a diaphragm of the present invention, signal reproduction characteristics can be flattened as compared with conventional one, so that appropriate signal reproduction can be performed by adopting it in a loudspeaker.

1. A diaphragm for a loudspeaker comprising:
a shape overlapping a first circle and a second circle in a top view of an outer periphery shape of the diaphragm,
wherein the first circle has a first center point and a first radius, and the second circle has a second center point different from the first center point and a second radius different from the first radius.

2. The diaphragm for the loudspeaker of claim 1,
wherein a through-hole for fixing a voice coil is formed at a center of the diaphragm, and
the diaphragm has an edge-fixing part for being fixed to a loudspeaker frame via an edge at its outer periphery.

3. A diaphragm comprising:
a through-hole for fixing a voice coil formed at a center of the diaphragm; and
an edge-fixing part at an outer periphery of the diaphragm,
wherein the outer periphery of the diaphragm is substantially circular, and
the outer periphery of the diaphragm has a shape that a first circle and a second circle are overlapped each other with their center points displaced in such a manner that at least one part of an outer periphery of the first circle and the second circle forms a part of the substantially circular outer periphery.

4. The diaphragm of claim 3,
wherein center points of the first circle and the second circle are displaced from a center point of an entire shape of the diaphragm.

5. A loudspeaker comprising:
a magnetic circuit including a magnetic gap;
a cylindrical voice coil whose end is inserted into the magnetic gap;
a diaphragm fixed to an other end of the voice coil; and
a frame holding an outer periphery of the diaphragm via an edge,
wherein a through-hole for fixing the voice coil is formed at a center of the diaphragm,
wherein the diaphragm has a shape overlapping a first circle and a second circle in a top view of an outer periphery shape of the diaphragm, and
wherein the first circle has a first center point and a first radius, and the second circle has a second center point different from the first center point and a second radius different from the first radius.

6. The loudspeaker of claim 5,
wherein the diaphragm has a third circle, the third circle surrounds both the first circle and the second circle, and the third circle contacts with outer peripheries of the first circle and the second circle, and
a center point of the third circle is a center point of the diaphragm.

7. The loudspeaker of claim 5,
wherein the outer periphery of the diaphragm has a shape that the first circle and the second circle are overlapped each other with their center points displaced in such a manner that at least one part of an outer periphery of the first circle and the second circle forms a part of the substantially circular outer periphery.

8. The loudspeaker of claim 7,
wherein center points of the first circle and the second circle are displaced from a center point of an entire shape of the diaphragm.
